(19) United States
(12) Patent Application Publication
(10) Pub. No.: US 2011/0315400 A1
(43) Pub. Date: Dec. 29, 2011

(54) TUBULAR POSITIONING SYSTEM AND METHOD OF SELECTIVELY POSITIONING TUBULARS

(75) Inventor: Thomas J. Zweifel, Cypress, TX (US)

(73) Assignee: Baker Hughes Incorporated, Houston, TX (US)

(21) Appl. No.: 12/821,498

(22) Filed: Jun. 23, 2010

(51) Int. Cl. E21B 23/01; E21B 23/00; E21B 17/08; B23P 19/04; F16L 21/00

(52) U.S. Cl. 166/382; 29/428; 285/331; 166/242.6

(57) ABSTRACT

A tubular positioning system includes a first tubular having a plurality of unique inner profiles disposed at an inner surface thereof and a plurality of second tubulars, each having a unique outer profile disposed at an outer surface thereof, that are runnable within the first tubular. The tubular positioning system is configured such that each of the plurality of second tubulars is prevented from passing one of the unique inner profiles when the unique outer profile thereon engages with one of the unique inner profiles. Each of the plurality of second tubulars is passable by each one of the unique inner profiles when the unique outer profile thereon is non-engagable with the one of the unique inner profiles.

### BACKGROUND

Tubular systems, such as those employed for transporting fluid often incorporate a plurality of tubulars that are movable sometime including moving one or more of the tubulars within another. Longitudinally positioning each of a plurality of the tubulars to specific positions within another of the tubulars has several useful benefits. For example, in a downhole application tubulars that serve as diverters could be positioned at desired locations along a casing to thereby allow additional tubulars run therein to be diverted though windows in the casing. New systems and methods, therefore that allow for such positioning are well received in the art.

### BRIEF DESCRIPTION

Disclosed herein is a tubular positioning system which includes a first tubular having a plurality of unique inner profiles disposed at an inner surface thereof and a plurality of second tubulars, each having a unique outer profile disposed at an outer surface thereof, and runnable within the first tubular. The tubular positioning system is configured such that each of the plurality of second tubulars is prevented from passing one of the unique inner profiles when the unique outer profile thereon engages with one of the unique inner profiles. Each of the plurality of second tubulars is passable by each one of the unique inner profiles when the unique outer profile thereon is non-engagable with the one of the unique inner profiles.

Further disclosed is a method of selectively positioning tubulars including positioning a plurality of unique inner profiles along an inner surface of a first tubular, sequentially running each of a plurality of second tubulars having unique outer profiles thereon within the first tubular, and selectively passing or engaging each of the plurality of unique inner profiles with each of the unique outer profiles. The passing allows longitudinal passage of the plurality of second tubulars thereby and the engaging longitudinally prevents passage of the one of the plurality of second tubulars thereby.

### BRIEF DESCRIPTION OF THE DRAWINGS

The following descriptions should not be considered limiting in any way. With reference to the accompanying drawings, like elements are numbered alike:

FIG. 1 depicts a cross sectioned view of a tubular positioning system disclosed herein;

FIG. 2 depicts partial cross sectioned views of three different embodiments of unique inner profiles, employable in the tubular positioning system of FIG. 1, engaged with their complementary unique outer profiles;

FIG. 3 depicts a cross sectioned view of a first tubular having an unique inner profile disclosed herein;

FIG. 4 depicts a cross sectioned view of a second tubular having an unique outer profile disclosed herein; and

FIG. 5 depicts a cross sectioned view of an inner profile of a second tubular engaged with an outer profile of a third tubular disclosed herein.

### DETAILED DESCRIPTION

A detailed description of one or more embodiments of the disclosed apparatus and method are presented herein by way of exemplification and not limitation with reference to the Figures.

Among other things, embodiments of the tubular positioning system disclosed herein allow an operator to selectively position each of a plurality of tubulars within another tubular at selected longitudinal locations therealong.

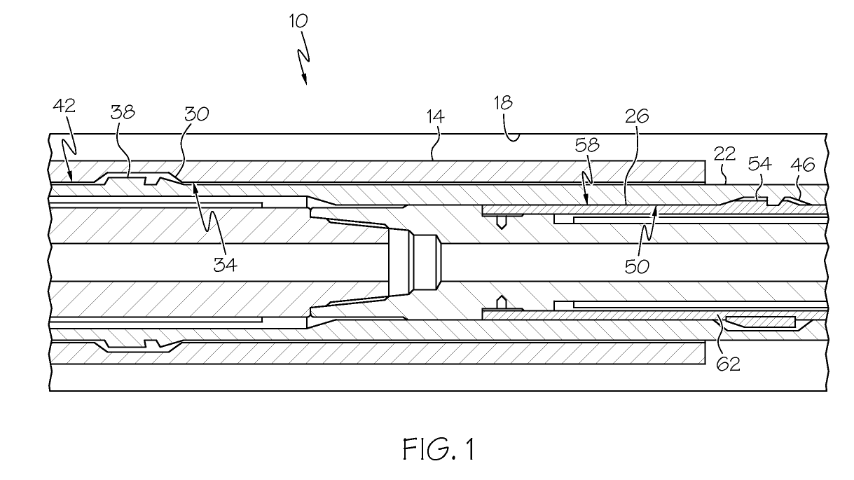

Referring to FIG. 1, an embodiment of a tubular positioning system disclosed herein is illustrated at 10. The positioning system 10 includes, a first tubular 14, shown herein as a casing within a wellbore 18, a second tubular 22, shown herein as a diverter, and a third tubular 26, shown herein as a running tool. The first tubular 14 has a plurality of unique inner profiles 30, with one being shown, disposed on an inner surface 34 thereof and the second tubular 22 has a unique outer profile 38 on an outer surface 42 thereof. Additional details regarding the profiles 30, 38 will be provided below. Each of the unique outer profiles 38 is engagable with one of the unique inner profiles 30 that it is complementary thereto regardless of rotational orientation therebetween. Additionally, the second tubular 22 has an inner profile 46 disposed at an inner surface 50 thereof engagable with an outer profile 54 disposed on an outer surface 58 of the third tubular 26 that is complementary thereto.

The foregoing structure allows an operator of the system 10 to attach the second tubular 22 to the third tubular 26 with engagement of the inner profile 46 with the outer profile 54. This attachment allows the second tubular 22 to be run within the first tubular 14 along with the running of the third tubular 26. As the running is performed, the unique outer profile 38 will sequentially encounter each of the plurality of unique inner profiles 30. Since, by design, the unique outer profile 38 has only one complementary unique inner profile 30 engagable therewith, the unique outer profile 38 will pass by each of the non-complementary unique inner profiles 30. Upon encountering the complementary unique inner profile 30, the unique outer profile 38 will engage therewith, thereby preventing the second tubular 22 from running further within the first tubular 14.

By mounting at least one of the inner profile 46 and the outer profile 54 on a radially flexible member, such as collet 62, for example, the outer profile 54 can be made to disengage upon movement of the third tubular 26 in a direction opposite to the running direction (which in this embodiment is in an upward direction), as long as the second tubular 22 is held engaged with the first tubular 14 with greater holding force than is required to disengage the outer profile 54 from the inner profile 46. This disengagement allows the third tubular 26 to be withdrawn from the second tubular 22. In an application where the second tubular 22 is a diverter (as is the case of this embodiment), this withdrawal will permit the third tubular 26 to then be rerun within the diverter 22 and diverted through a window (not shown) in the first tubular 14 in the process.

The plurality of unique inner profiles 30 allows for any number of diverters 22 to be positioned longitudinally along the first tubular 14. It may be desirable to situate the plurality of unique inner profiles 30 along the first tubular 14 in such a manner that the first diverter 22 will run past all but the last of the unique inner profiles 30 before the unique outer profile 38 disposed thereat engages with its complementary unique inner profile 30. Doing so will allow an operator to engage each and every one of the plurality of unique inner profiles 30 with a complementary unique outer profile 38. As such, each inner profile 30 can have a window associated therewith that one of the diverters 22 will be positioned relative thereto for diverting a tubular run thereagainst through the associated window.

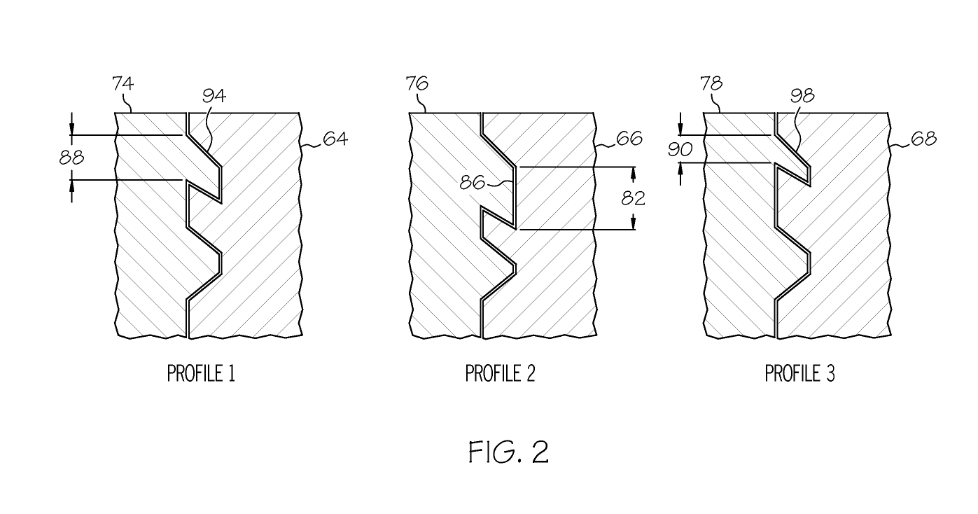

Referring to FIG. 2, examples of three unique inner profiles 30 are illustrated at 64, 66 and 68 in engaged positions with their complementary unique outer profiles 38 illustrated at 74, 76 and 78. One of ordinary skill in the art will appreciate that a longitudinal dimension 82 of a tooth 86 of the second unique outer profile 76 is greater than corresponding longitudinal dimensions 88, 90 of slots 94, 98 of the unique inner profiles 64 and 68, thereby making them non-complementary. The difference between the dimension 82 and the dimensions 88, 90 prevent the second unique outer profile 76 from engaging with either of the unique inner profiles 64 or 68. As such, a second tubular 22 having the unique outer profile 76 thereon will pass both of the unique inner profiles 64 and 68 without engaging with either one.

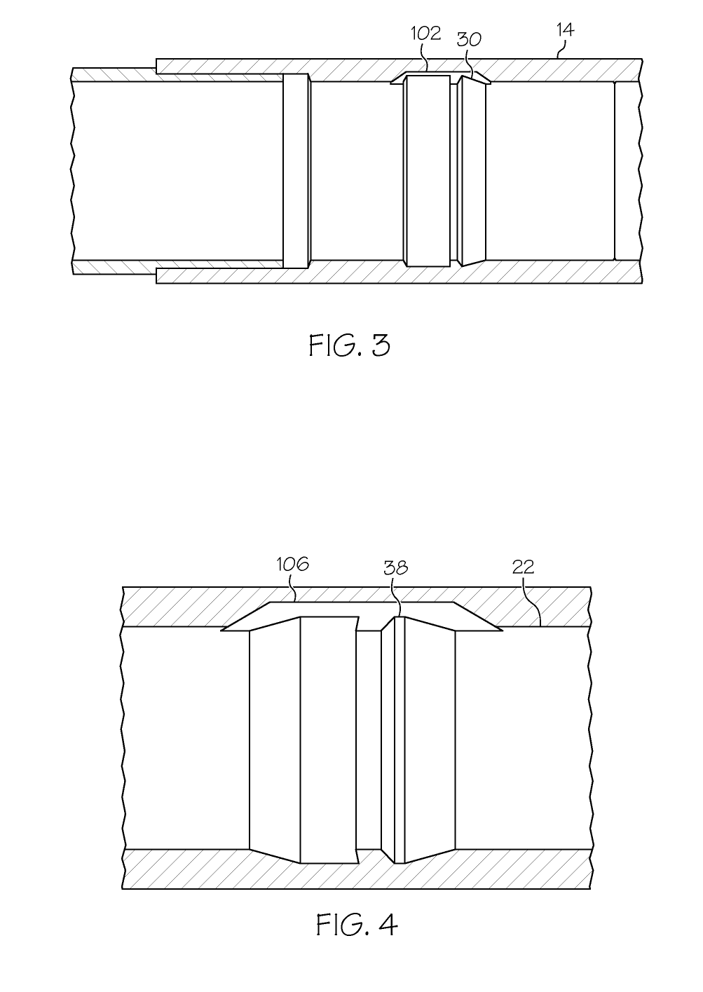

FIG. 3 illustrates a torque shoulder 102 on the unique inner profile 30 of the first tubular 14 that is contactable with a torque shoulder 106 on the unique outer profile 38 of the second tubular 22 illustrated in FIG. 4. The shoulders 102, 106 allow the second tubular 22 to be rotationally oriented to a selected position relative to the first tubular 14. Relative rotation between the second tubular 22 and the first tubular 14 will cease when the shoulders 102, 106 contact one another. This feature would be useful, for example, in an embodiment wherein the first tubular 14 includes a window and the second tubular 22 is a diverter that must be rotationally aligned with the window to correctly divert the third tubular 26 into the window upon running thereagainst. One or both of the torque shoulders 102, 106 may be biased radially via biasing members such as springs or collets (not shown) to assure interference therebetween during rotational motion therebetween. The torque shoulders 102, 106 may be configured to prevent rotation of the first tubular 14 relative to the second tubular 22 in both directions once contact between them has been achieved.

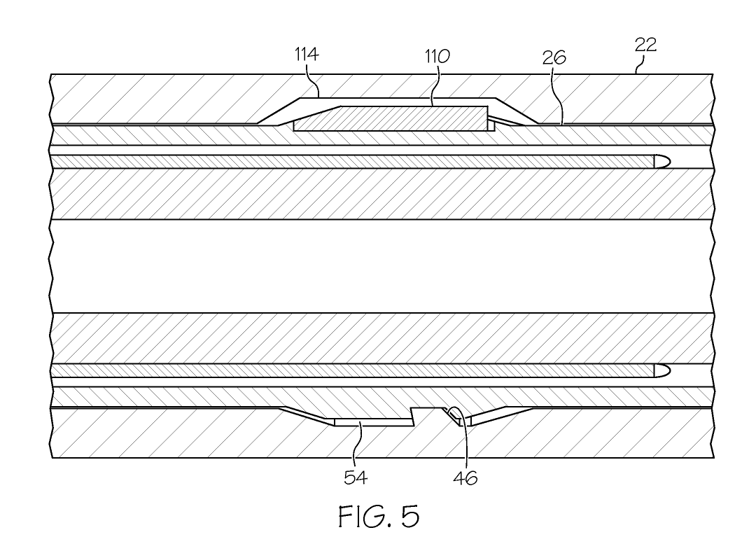

FIG. 5, illustrates how the third tubular 26 can be configured to cause rotation of the second tubular 22. A torque shoulder 110 on the outer profile 54 of the third tubular 26 contacts a torque shoulder 114 on the inner profile 46 of the second tubular 22. This ability to transfer torque between the third tubular 26 and the second tubular 22 allows an operator to rotate the second tubular 22 relative to the first tubular 14 for the reasons stated above.

The foregoing tubular positioning system 10 allows an operator to run multiple diverters 22 into the wellbore 18 and to selectively position each of the diverters, both longitudinally and rotationally, relative to the wellbore.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A tubular positioning system comprising:
a first tubular having a plurality of unique inner profiles disposed at an inner surface thereof; and
a plurality of second tubulars, each having a unique outer profile disposed at an outer surface thereof, being runnable within the first tubular, the tubular positioning system being configured such that each of the plurality of second tubulars is prevented from passing one of the unique inner profiles when the unique outer profile thereon engages with one of the unique inner profiles and each of the plurality of second tubulars is passable by each one of the unique inner profiles when the unique outer profile thereon is non-engagable with the one of the unique inner profiles.

2. The tubular positioning system of claim 1, wherein each of the plurality of unique outer profiles is configured to engage with a complementary unique inner profile and to not engage with a non-complementary unique inner profile.

3. The tubular positioning system of claim 2, wherein the plurality of unique inner profiles and the plurality of unique outer profiles are configured to be engagable with their complementary counterpart regardless of rotational orientation of the plurality of second tubulars relative to the first tubular.

4. The tubular positioning system of claim 2, wherein engagement of the complementary unique profiles resist withdrawal of the second tubular from the first tubular at loads below a threshold value.

5. The tubular positioning system of claim 1, wherein at least one of the plurality of unique inner profiles and the plurality of unique outer profiles are radially movable relative to the tubular on which it is disposed.

6. The tubular positioning system of claim 1, wherein each of the plurality of unique inner profiles include a shoulder configured to rotationally contact a shoulder of the unique outer profile that is engagable therewith.

7. The tubular positioning system of claim 6, wherein the shoulders are configured to allow for rotational orientation of each of the plurality of second tubulars to the first tubular.

8. The tubular positioning system of claim 1, wherein at least one of the plurality of second tubulars is a diverter configured to divert tools through a window in the first tubular upon positioning relative thereto.

9. The tubular positioning system of claim 1, wherein the plurality of second tubulars each include an inner profile engagable with an outer profile of a third tubular.

10. The tubular positioning system of claim 9, wherein withdrawing disengagement forces between the profiles engaging the third tubular with the second tubular are less than withdrawing disengagement forces between the unique inner profiles of the first tubular with the unique outer profiles of the second tubulars.

11. The tubular positioning system of claim 9, wherein the plurality of unique inner profiles include a torque shoulder contactable with a shoulder of the outer profile.

12. A method of selectively positioning tubulars comprising:
positioning a plurality of unique inner profiles along an inner surface of a first tubular;
sequentially running each of a plurality of second tubulars having unique outer profiles thereon within the first tubular; and
selectively passing or engaging each of the plurality of unique inner profiles with each of the unique outer profiles, the passing allowing longitudinal passage of the one of the plurality of second tubulars thereby and the engaging longitudinally preventing passage of the one of the plurality of second tubulars thereby.

13. The method of selectively positioning tubulars of claim 12, further comprising rotating the one of the plurality of second tubulars relative to the first tubular after engaging.

14. The method of selectively positioning tubulars of claim 12, further comprising rotationally orienting the one of the plurality of second tubulars to the first tubular.

15. The method of selectively positioning tubulars of claim 14, wherein the rotationally orienting includes contacting a shoulder of the one of the plurality of unique inner profiles with a shoulder of the unique outer profile engaged therewith.

16. The method of selectively positioning tubulars of claim 12, further comprising running a third tubular with the sequentially running of each of the plurality of second tubulars.

17. The method of selectively positioning tubulars of claim 16, further comprising rotating the one of the plurality of second tubulars relative to the first tubular with the third tubular.

18. The method of selectively positioning tubulars of claim 16, further comprising withdrawing the third tubular from the one of the plurality of second tubulars.

19. The method of selectively positioning tubulars of claim 18, further comprising diverting the third tubular through a window in the first tubular with the second tubular.
